(19) United States
(12) Patent Application Publication
(10) Pub. No.: US 2011/0053996 A1
(43) Pub. Date: Mar. 3, 2011

(54) Use of phenyltriazoles for controlling insects and spider mites by watering, droplet application or dip application or by treating seed

(75) Inventors: Wolfram Andersch, Bergisch Gladbach (DE); Leonardo Pitta, Leverkusen (DE); Heike Hungenberg, Langenfeld (DE)

(73) Assignee: Bayer CropScience AG, Monheim am Rhein (DE)

(21) Appl. No.: 12/836,696

(22) Filed: Jul. 15, 2010

(30) Foreign Application Priority Data
Jul. 16, 2009 (EP) 09165661.1

(51) Int. Cl. A01N 43/653; A01P 7/04; A01P 5/00; A01P 7/02

(52) U.S. Cl. 514/383

(57) ABSTRACT

The present invention relates to the use of compounds of the formula (I)

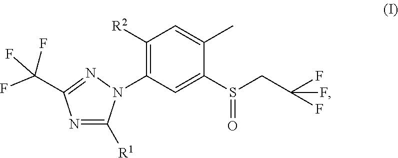

in which R¹, R² may have the meanings given in the description-, for controlling animal pests such as insects and/or spider mites and/or nematodes by treating the soil/growth substrate by watering, by droplet application, by dip (immersion) application or by treating the seed.

The present invention relates to the use of phenyltriazoles for controlling insects and/or spider mites and/or nematodes by watering, droplet application, dip (immersion) application or by treating seed.

Phenyltriazoles have already been described in WO 1999/55668 and WO 2006/043635. These documents also report an insecticidal action.

Surprisingly, it has now been found that phenyltriazole derivatives are also highly suitable for controlling insects and spider mites by watering on the ground (known as “drenching” by persons skilled in the art), droplet application on the ground (known as “drip application” by persons skilled in the art), dip application or by treating seed.

Accordingly, the present invention relates to the use of phenyltriazoles for controlling insects and/or spider mites and/or nematodes by drenching, in irrigation systems as drip application or by dip application and for seed treatment. The present invention relates in particular to these application forms on artificial soilless cultivation substrates (for example rock wool, glass wool, quartz sand, gravel, expanded clay, vermiculite), outdoors or in closed systems (for example greenhouses or under cloches) and in annual (for example vegetables, spices, ornamental plants), but also perennial (for example citrus plants, conifers, ornamental plants, shrubs) crops.

The crops to be protected which have only been described in general terms will be described in greater detail and specified hereinbelow. Thus, as regards the use, vegetables are understood as meaning for example fruiting vegetables and inflorescences as vegetables, for example bell peppers, chillies, tomatoes, aubergines, cucumbers, pumpkins, courgettes, broad beans, runner beans, dwarf beans, peas, artichokes, maize;

but also leafy vegetables, for example head-forming lettuce, chicory, endives, various types of cress, of rocket, lamb's lettuce, iceberg lettuce, leeks, spinach, Swiss chard;

furthermore tuberous, root and stalk vegetables, for example celeriac, red beetroot, carrots, radishes, horseradish, salsify, asparagus, turnips, palm shoots, bamboo shoots, moreover allium vegetables, for example onions, leek, fennel, garlic;

furthermore Brassica vegetables such as cauliflower, broccoli, kohlrabi, red cabbage, white cabbage, curly kale, Savoy cabbage, Brussel sprouts, Chinese cabbage.

Regarding the use, perennial crops are understood as meaning citrus, such as, for example, oranges, grapefruits, tangerines, lemons, limes, Seville oranges, kumquats, satsumas;

but also pome fruit such as, for example, apples, pears and quinces, and stone fruit, such as, for example, peaches, nectarines, cherries, plums, quetsch, apricots;

furthermore grapevines, hops, olives, tea and tropical crops such as, for example, mangoes, papayas, figs, pineapples, dates, bananas, durians, kaki fruit, coconuts, cacao, coffee, avocados, lychees, maracujas, guavas,

moreover almonds and nuts such as, for example, hazelnuts, walnuts, pistachios, cashew nuts, para nuts, pecan nuts, butternuts, chestnuts, hickory nuts, macadamia nuts, peanuts,

moreover also soft fruit such as, for example, redcurrants, gooseberries, raspberries, blackberries, blueberries, strawberries, cranberries, including American cranberries, kiwi fruit.

Regarding the use, ornamental plants are understood as meaning annual and perennial plants, for example cut flowers such as, for example, roses, carnations, gerbera, lilies, marguerites, chrysanthemums, tulips, narcissi, anemones, poppy, amaryllis, dahlias, azaleas, mallows,

but also for example bedding plants, pot plants and perennials such as, for example, roses, Tagetes, violas, geraniums, fuchsias, hibiscus, chrysanthemum, busy lizzie, cyclamen, African violet, sunflowers, begonias,

furthermore for example bushes and conifers such as, for example, ficus, rhododendron, firs, spruces, pines, including umbrella pines, yews, juniper, oleander.

As regards the use, spices are understood as meaning annual and perennial plants such as, for example, aniseed, chili pepper, paprika, pepper, vanilla, marjoram, thyme, cloves, juniper berries, cinnamon, tarragon, coriander, saffron, ginger.

The general formula (I) provides a definition of the phenyltriazoles according to the invention which can be used insecticidally and/or acaricidally and/or nematicidally

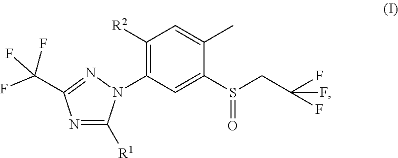

in which
R¹ represents H or NH₂,
R² represents CH₃ or F.

Preferred sub-groups of the compounds of the formula (I) are listed below.

In a special group of compounds of the formula (I), R¹ represents hydrogen.

In a further special group of compounds of the formula (I), R¹ represents NH₂.

In a further special group of compounds of the formula (I), R² represents methyl.

In a further special group of compounds of the formula (I), R² represents fluorine.

A preferred sub-group of the compounds of the formula (I) are those of the formula (I-1)

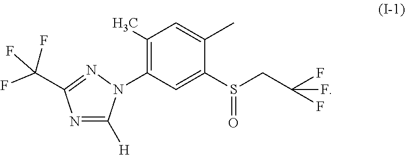

A further preferred sub-group of the compounds of the formula (I) are those of the formula (I-2)

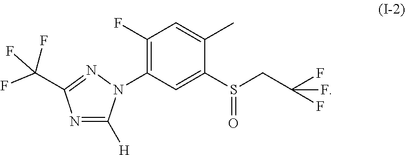

A further preferred sub-group of the compounds of the formula (I) are those of the formula (I-3)

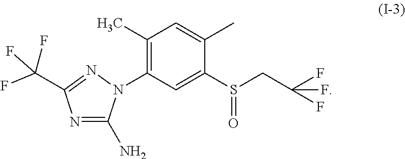

A further preferred sub-group of the compounds of the formula (I) are those of the formula (I-4)

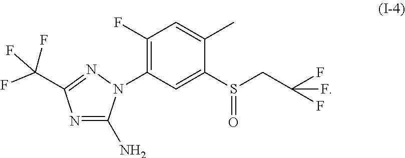

The compounds of the general formula (I) have a chiral sulphoxide group so that, provided further centres of chirality are absent, they form two enantiomers having R or S configuration at the sulphur:

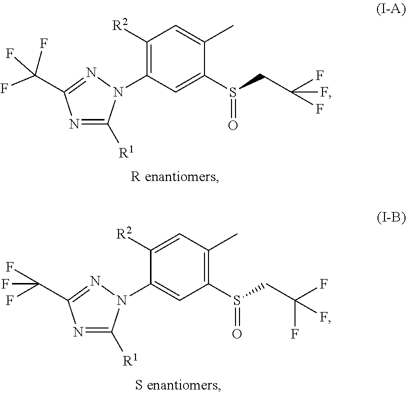

where R¹, R² have the meanings given above.

In the synthesis from achiral starting materials the two enantiomers are formed in equal amount so that a racemate is present. The separation of the racemate known from the literature (cf. WO 1999/055668 and WO 2006/043635) into the individual enantiomers can be carried out by preparative HPLC on a chiral stationary phase. The separation may take place, for example, on a Daical Chiralpak AD-H 250 mm×30 mm column using a mobile phase of n-heptane/ethanol/methanol 60:20:20 (v/v/V), a flow rate of 30 ml/min and UV detection at 220 nm. The two enantiomers can then be characterized by methods known from the literature, for example by X-ray structural analysis or by determining the optical rotation.

Accordingly, the present invention also provides the use of phenyltriazoles comprising the R or S enantiomers of the compounds of the formula (I).

Particularly preferred sub-groups of the compounds of the formula (I) are the respective R or S enantiomers of the formulae (I-1A), (I-1B), (I-2A), (I-2B), (I-3A), (I-3B), (I-4A), (I-4B):

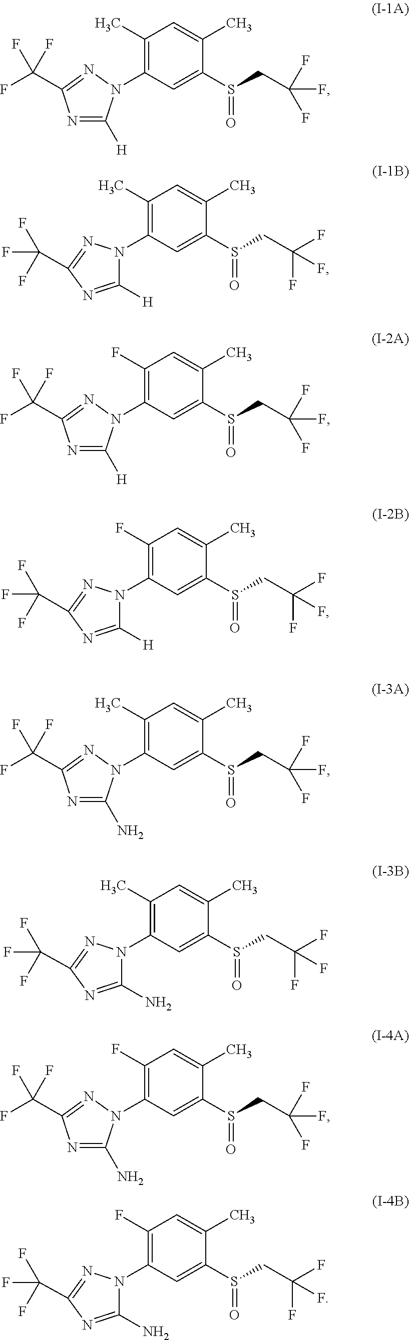

The use according to the invention of the phenyltriazole derivatives is against a large variety of animal pests, in particular insects, arachnids, helminths, nematodes and molluscs, which are encountered in agriculture, in horticulture, in forests and in gardens and leisure facilities, against normally sensitive and resistant species and against all or some stages of development. These pests include:

From the order of the Anoplura (Phthiraptera), for example, Damalinia spp., Haematopinus spp., Linognathus spp., Pediculus spp., Trichodectes spp.

From the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Deimanyssus gallinae, Eutetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici.

From the class of the Bivalva, for example, Dreissena spp.

From the order of the Chilopoda, for example, Geophilus spp., Scutigera spp.

From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chrysocephala, Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus spp.

From the order of the Collembola, for example, Onychiurus armatus.

From the order of the Dennaptera, for example, Forficula auricularia.

From the order of the Diplopoda, for example, Blaniulus guttulatus.

From the order of the Diptera, for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp., Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.

From the class of the Gastropoda, for example, Arion spp., Biomphalaria spp., Bulinus spp., Deroceras spp., Galba spp., Lymnaea spp., Oncomelania spp., Succinea spp.

From the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius vezniicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

It is furthermore possible to control Protozoa, such as Eimeria.

From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.

From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma pini, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosorna spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus anticulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii.

From the order of the Hymenoptera, for example, Diprion spp., Hoplocampa spp., Lasius spp., Monomorium pharaonis and Vespa spp.

From the order of the Isopoda, for example, Armadillidium vulgare, Oniscus asellus and Porcellio scaber.

From the order of the Isoptera, for example, Reticulitermes spp. and Odontotermes spp.

From the order of the Lepidoptera, for example, Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Chematobia brumata, Chilo spp., Choristoneura fumiferana, Clysia ambiguella, Cnaphalocerus spp., Earias insulana, Ephestia kuehnielia, Euproctis chrysorrhoea, Euxoa spp., Feltia spp., Galleria mellonella, Helieoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Theimesia gemmatalis, Tinea pellionella, Tineola bisselliella, ToiLiix viridana, Trichoplusia spp.

From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.

From the order of the Siphonaptera, for example, Ceratophyllus spp. and Xenopsylla cheopis.

From the order of the Symphyla, for example, Scutigerella immaculata.

From the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.

From the order of the Thysanura, for example, Lepisma saccharina.

The phytoparasitic nematodes include, for example, Anguina spp., Aphelenchoides spp., Belonoaimus spp Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Xiphinema spp.

The use according to the invention of the phenyltriazole derivatives can be on its own, but also in combination with other active compounds. Accordingly, compositions to be used according to the invention may, in addition to at least one phenyltriazole derivative, also comprise other active compounds, such as further systemic insecticides, attractants, sterilants, bactericides, systemic acaricides, nematicides, fungicides, growth-regulating substances, herbicides, safeners, fertilizers or semiochemicals.

The compositions to be used according to the invention may furthermore comprise synergists. Synergists are compounds which increase the action of the active compounds, without it being necessary for the synergist added to be active itself.

The compositions to be used according to the invention may furthermore comprise inhibitors which reduce degradation of the active compound after application.

All plants can be treated in accordance with the invention. In a preferred embodiment, wild plant species and plant cultivars, or those obtained by conventional biological breeding, such as crossing or protoplast fusion, and also parts thereof, are treated. In a further preferred embodiment, transgenic plants and plant cultivars obtained by genetic engineering, if appropriate in combination with conventional methods (Genetically Modified Organisms), are treated.

Particularly preferably, plants of the plant cultivars which are in each case commercially available or in use are treated according to the invention. Plant cultivars are to be understood as meaning plants having new properties (“traits”) and which have been obtained by conventional breeding, by mutagenesis or by recombinant DNA techniques. They can be cultivars, biotypes or genotypes.

Depending on the plant species or plant cultivars, their location and growth conditions (soils, climate, vegetation period, nutrition), the treatment according to the invention may also result in superadditive (“synergistic”) effects. Thus possible are, for example, reduced application rates and/or a widening of the activity spectrum and/or an increase of the activity of the compositions according to the invention, better plant growth, increased tolerance to high or low temperatures, increased tolerance to drought or to water or soil salt content, increased flowering, easier harvesting, accelerated maturation, higher harvest yields, higher quality and/or higher nutritional value of the harvested products, increased storability and/or processibility of the harvested products, which exceed the effects normally to be expected.

The preferred transgenic plants or plant cultivars (i.e. those obtained by genetic engineering) which are to be treated according to the invention include all plants which, in the genetic modification, received genetic material which imparted particularly advantageous useful properties (“traits”) to these plants. Examples of such properties are better plant growth, increased tolerance to high or low temperatures, increased tolerance to drought or to water or soil salt content, increased flowering, easier harvesting, accelerated maturation, higher harvest yields, higher quality and/or a higher nutritional value of the harvested products, better storability and/or processability of the harvested products. Further and particularly emphasized examples of such properties are a better defense of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, sugar beet, tomatoes, peas and other types of vegetable, cotton, tobacco, oilseed rape and also fruit plants (with the fruits apples, pears, citrus fruits and grapes), with particular emphasis being given to maize, soya beans, potatoes, cotton, tobacco and oilseed rape. Traits that are emphasized in particular are increased defense of the plants against insects, arachnids, nematodes and slugs and snails by toxins foamed in the plants, in particular those formed in the plants by the genetic material from Bacillus thuringiensis (for example by the genes CryIA(a), CryIA(b), CryIA(c), CryIIA, CryIIIA, CryIIIB2, Cry9c Cry2Ab, Cry3Bb and CryIF and also combinations thereof) (hereinbelow referred to as “Bt plants”). Traits that are also particularly emphasized are the increased defense of the plants against fungi, bacteria and viruses by systemic acquired resistance (SAR), systemin, phytoalexins, elicitors and also resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinothricin (for example the “PAT” gene). The genes which impart the desired traits in question can also be present in combinations with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance against glyphosate, for example maize, cotton, soya beans), Liberty Link® (tolerance against phosphinothricin, for example oilseed rape), IMI® (tolerance against imidazolinones) and STS® (tolerance against sulphonylurea, for example maize). Herbicide-resistant plants (plants bred in a conventional manner for herbicide tolerance) which may be mentioned include the varieties sold under the name Clearfield® (for example maize). Of course, these statements also apply to plant cultivars having these genetic traits or genetic traits still to be developed, which plants will be developed and/or marketed in the future.

The use according to the invention of the phenyltriazole derivatives is by drenching, in irrigation systems as drip application, by dip application or, in the case of propagation material, in particular in the case of seed, furthermore by application of one or more coats.

Preference according to the invention is given to the treatment of seed. Thus, most of the damage to crop plants which is caused by pests occurs as early as when the seed is infested during storage and after the seed is introduced into the soil, and during and immediately after germination of the plants. This phase is particularly critical since the roots and shoots of the growing plants are particularly sensitive and even minor damage can lead to the death of the whole plant. Protecting the seed and the germinating plant by the use of suitable compositions is therefore of particularly great interest.

The control of pests by treating the seed of plants has been known for a long time and is the subject of continuous improvements. However, the treatment of seed entails a series of problems which cannot always be solved in a satisfactory manner. Thus, it is desirable to develop methods for protecting the seed and the germinating plant which dispense with the additional application of crop protection products after sowing or after emergence of the plants. It is furthermore desirable to optimize the amount of active compound employed in such a way as to provide optimum protection for the seed and the germinating plant from attack by pests, but without damaging the plant itself by the active compound employed. In particular, methods for the treatment of seed should also take into consideration the intrinsic insecticidal properties of transgenic plants in order to achieve optimum protection of the seed and the germinating plant with a minimum of crop protection products being employed.

The present invention therefore in particular also relates to a method for the protection of seed and germinating plants, from attack by pests, by treating the seed with an active compound according to the invention. The invention likewise relates to the use of phenyltriazoles for the treatment of seed for protecting the seed and the plants resulting therefrom from pests. Furthermore, the invention relates to seed which has been treated according to the invention so as to afford protection from pests.

One of the advantages of the present invention is that the particular systemic properties of phenyltriazole derivatives mean that treatment of the seed with these active compounds not only protects the seed itself, but also the resulting plants after emergence, from pests. In this manner, the immediate treatment of the crop at the time of sowing or shortly thereafter can be dispensed with.

Furthermore, it must be considered as advantageous that according to the invention the phenyltriazoles can also be employed in particular in transgenic seed, the plants arising from this seed being capable of expressing a protein directed against pests. By treating such seed, certain pests can be controlled merely by the expression of the, for example, insecticidal protein, and additionally damage to the seed may be averted by the active compounds according to the invention.

The use according to the invention of the phenyltriazole derivatives is suitable for protecting seed of any plant variety as already mentioned above which is employed in agriculture, in the greenhouse, in forests or in horticulture. In particular, this takes the form of seed of maize, peanut, canola, oilseed rape, poppy, soya beans, cotton, beet (for example sugar beet and fodder beet), rice, millet, wheat, barley, oats, rye, sunflower, tobacco, potatoes or vegetables (for example tomatoes, cabbage species). The active compounds according to the invention are likewise suitable for treating the seed of fruit plants and vegetables as already mentioned above. The treatment of the seed of maize, soya beans, cotton, wheat, rice and canola or oilseed rape is of particular importance.

As already mentioned above, the treatment of transgenic seed with active compounds according to the invention is also of particular importance. This takes the form of seed of plants which, as a rule, comprise at least one heterologous gene which governs the expression of a polypeptide with in particular insecticidal properties. In this context, the heterologous genes in transgenic seed may be derived from microorganisms such as Bacillus, Rhizobiwn, Pseudomonas, Serratia, Trichoderma, Clavibacter, Glomus or Gliocladium. The present invention is particularly suitable for the treatment of transgenic seed which comprises at least one heterologous gene originating from Bacillus sp. and whose gene product shows activity against the European corn borer and/or the corn root worm. It is particularly preferably a heterologous gene derived from Bacillus thuringiensis.

Within the context of the present invention, the phenyltriazole derivatives are applied to the seed either alone or in a suitable formulation. Preferably, the seed is treated in a state in which it is stable enough to avoid damage during treatment. In general, the seed may be treated at any point in time between harvest and sowing. The seed usually used has been separated from the plant and freed from cobs, shells, stalks, coats, hairs or the flesh of the fruits.

When treating the seed, care must generally be taken that the amount of the phenyltriazole derivatives applied to the seed and/or the amount of further additives is chosen in such a way that the germination of the seed is not adversely affected, or that the resulting plant is not damaged.

The compositions according to the invention can be applied directly, i.e. without containing any other components and undiluted. In general, it is preferred to apply the compositions to the seed in the form of a suitable formulation. Suitable formulations and methods for treating seed are known to the person skilled in the art and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

The active compounds which can be used in accordance with the invention can be converted into the customary seed-dressing formulations, such as solutions, emulsions, suspensions, powders, foams, slurries or other coating compositions for seed, and also ULV formulations.

These formulations are prepared in a known manner, by mixing the active compounds with customary additives such as, for example, customary extenders and also solvents or diluents, colorants, wetting agents, dispersants, emulsifiers, antifoams, preservatives, secondary thickeners, adhesives, gibberellins and also water.

Colorants which may be present in the seed-dressing formulations which can be used in accordance with the invention are all colorants which are customary for such purposes. In this context, not only pigments, which are sparingly soluble in water, but also dyes, which are soluble in water, may be used. Examples which may be mentioned are the colorants known by the names Rhodamin B, C.I. Pigment Red 112 and C.I. Solvent Red 1.

Suitable wetting agents which may be present in the seed-dressing formulations which can be used in accordance with the invention are all substances which promote wetting and which are conventionally used for the formulation of agrochemical active compounds. Preference is given to using alkylnaphthalenesulphonates, such as diisopropyl- or diisobutylnaphthalenesulphonates.

Suitable dispersants and/or emulsifiers which may be present in the seed-dressing formulations which can be used in accordance with the invention are all nonionic, anionic and cationic dispersants conventionally used for the formulation of agrochemical active compounds. Preference is given to using nonionic or anionic dispersants or mixtures of nonionic or anionic dispersants. Suitable nonionic dispersants which may be mentioned are, in particular, ethylene oxide/propylene oxide block polymers, alkylphenol polyglycol ethers and tristyrylphenol polyglycol ether, and their phosphated or sulphated derivatives. Suitable anionic dispersants are, in particular, lignosulphonates, polyacrylic acid salts and arylsulphonate/formaldehyde condensates.

Antifoams which may be present in the seed-dressing formulations which can be used in accordance with the invention are all foam-inhibiting substances conventionally used for the formulation of agrochemical active compounds. Silicone antifoams and magnesium stearate can preferably be used.

Preservatives which may be present in the seed-dressing formulations which can be used in accordance with the invention are all substances which can be employed for such purposes in agrochemical compositions. Dichlorophene and benzyl alcohol hemiformal may be mentioned by way of example.

Secondary thickeners which may be present in the seed-dressing formulations which can be used in accordance with the invention are all substances which can be employed for such purposes in agrochemical compositions. Cellulose derivatives, acrylic acid derivatives, xanthan, modified clays and finely divided silica are preferred.

Adhesives which may be present in the seed-dressing formulations which can be used in accordance with the invention are all customary binders which can be employed in seed-dressing products. Polyvinylpyrrolidone, polyvinyl acetate, polyvinyl alcohol and tylose may be mentioned as being preferred.

Gibberellins which can be present in the seed-dressing formulations which can be used in accordance with the invention are preferably the gibberellins A1, A3 (=gibberellic acid), A4 and A7; gibberellic acid is especially preferably used. The gibberellins are known (cf. R. Wegler “Chemie der Pflanzenschutz- and Schädlingsbekämpfungsmittel” [Chemistry of crop protection agents and pesticides], vol. 2, Springer Verlag, 1970, p. 401-412).

The seed-dressing formulations which can be used in accordance with the invention can be employed for the treatment of a wide range of seed, including the seed of transgenic plants, either directly or after previously having been diluted with water. In this context, additional synergistic effects may also occur in cooperation with the substances foamed by expression.

All mixers which can conventionally be employed for the seed-dressing operation are suitable for treating seed with the seed-dressing formulations which can be used in accordance with the invention or with the preparations prepared therefrom by addition of water. Specifically, a procedure is followed during the seed-dressing operation in which the seed is placed into a mixer, the specific desired amount of seed-dressing formulations, either as such or after previously having been diluted with water, is added, and everything is mixed until the formulation is distributed uniformly on the seed. If appropriate, this is followed by a drying process.

The application rate of the seed-dressing formulations which can be used according to the invention may be varied within a relatively wide range. It depends on the respective content of the active compounds in the formulations and on the seed. The active compound combination application rates are generally between 0.001 and 50 g per kilogram of seed, preferably between 0.01 and 15 g per kilogram of seed.

### USE EXAMPLES

The examples below illustrate the invention, without limiting it in any way.

To produce a suspension concentrate, initially all liquid components are mixed with one another. In the next step, the solids are added and the mixture is stirred until a homogeneous suspension is formed. The homogeneous suspension is subjected first to coarse grinding and then to fine grinding, giving a suspension in which 90% of all solid particles have a particle size of less than 10 μm. Kelzan S and water are than added with stirring at room temperature. A homogeneous suspension concentrate is obtained. Contents are stated in % by weight.

### Example No. 1

### Tetranychus urticae Test on Aubergine; Drench Application (France)

To produce a suitable solution, the formulated product is mixed with water and diluted to the desired concentration.

Approx. 3-week-old aubergine plants (Solanum melongena) infected with a mixed population of the greenhouse red spider mite (Tetranychus urticae) are watered with the respective product solution (volume of water: 50 ml/plant): The stated concentration refers to the amount of active compound per plant.

After the desired period of time, the effect in % is determined. 100% means that all of the spider mites have been killed; 0% means that none of the spider mites have been killed.

In this test, the following product showed good systemic action:

TABLE 1
Tetranychus urticae on aubergines

| | | Time at which the | |
|---|---|---|---|
| | | mortality is | % Activity |
| | Concentration | determined/days after | (according to |
| Active compound | (mg of ai/plant) | treatment | Abbott) |
| (I-1) SC 025 | 20 | 23 | 99 |
| according to the | | | |
| invention | | | |

### Example No. 2

### Liriomyza spp. Test on Tomatoes; Drench Application (France)

To produce a suitable solution, the formulated product is mixed with water and diluted to the desired concentration.

Tomato plants (Solanum esculentum) at the 3-leaf stage (BBCH 13) infested with a mixed population of leaf-mining flies (Liriomyza spp.) are watered with the respective product solution (volume of water: 50 ml/plant): The stated concentration refers to the amount of active compound per plant.

After the desired period of time, the effect in % is determined. 100% means that all of the leaf-mining flies have been killed; 0% means that none of the leaf-mining flies have been killed.

In this test, the following product showed good systemic action:

TABLE 2
Liriomyza spp. on tomatoes

| | | Time at which the | |
|---|---|---|---|
| | | mortality is | % Activity |
| | Concentration | determined/days after | (according to |
| Active compound | (mg of ai/plant) | treatment | Abbott) |
| (I-1) SC 025 | 20 | 13 | 100 |
| according to the | | | |
| invention | | | |

### Example No. 3

### Phyllocnistis citrella Test on Oranges; Drench Application (Brasil)

To produce a suitable solution, the formulated product is mixed with water and diluted to the desired concentration.

Approx. 1-year-old orange trees (Citrus sinensis) infested with citrus leaf-mining moths (Phyllocnistis citrella) are watered with the respective product solution (volume of water: 50 ml/plant): The stated concentration refers to the amount of active compound per plant.

After the desired period of time, the effect in % is determined. 100% means that all of the leaf-mining moths have been killed; 0% means that none of the leaf-mining moths have been killed.

In this test, the following product showed good systemic action:

TABLE 3
Phyllocnistis citrella on orange trees

| | | Time at which the | |
|---|---|---|---|
| | | mortality is | % Activity |
| | Concentration | determined/days after | (according to |
| Active compound | (mg of ai/plant) | treatment | Abbott) |
| (I-1) SC 025 | 20 | 28 | 77.6 |
| according to the | | | |
| invention | | | |

### Example No. 4

### Toxoptera citricidus Test on Oranges; Drench Application (Brasil)

To produce a suitable solution, the formulated product is mixed with water and diluted to the desired concentration.

Orange trees of a height of 1 m (Citrus sinensis) infested with a mixed population of the citrus aphid (Toxoptera citricidus) are watered with the respective product solution (volume of water: 50 ml/plant): The stated concentration refers to the amount of active compound per plant.

After the desired period of time, the effect in % is determined. 100% means that all of the aphids have been killed; 0% means that none of the aphids have been killed.

In this test, the following product showed good systemic action:

TABLE 4
Toxoptera citricidus on orange trees

| | | Time at which the | |
|---|---|---|---|
| | | mortality is | % Activity |
| | Concentration | determined/days after | (according to |
| Active compound | (mg of ai/plant) | treatment | Abbott) |
| (I-1) SC 025 | 20 | 149 | 90 |
| according to the | | | |
| invention | | | |

### Example No. 5

### Liriomyza trifolii Test on Tomatoes; Drench Application (Italy)

To produce a suitable solution, the formulated product is mixed with water and diluted to the desired concentration.

Tomato plants (Solanum esculentum) at the 4-leaf stage (BBCH 14) infested with a mixed population of leaf-mining flies (Liriomyza trifolii) are watered with the respective product solution (volume of water: 200 ml/plant): The stated concentration refers to the amount of active compound per plant.

After the desired period of time, the effect in % is determined. 100% means that all of the leaf-mining flies have been killed; 0% means that none of the leaf-mining flies have been killed.

In this test, the following product showed good systemic action:

TABLE 5
Liriomyza trifolii on tomatoes

| | | Time at which the | |
|---|---|---|---|
| | | mortality is | % Activity |
| | Concentration | determined/days after | (according to |
| Active compound | (mg of ai/plant) | treatment | Abbott) |
| (I-4) SC 025 | 5 | 19 | 80.9 |
| according to the | | | |
| invention | | | |

### Example No. 6

### Tetranychus urticae Test on Bush Beans;

### Seed Application Greenhouse

To produce a suitable solution, the formulated product is mixed with water and diluted to the desired concentration.

Bush bean seed (Phaseolus vulgaris) is dressed with the active compound preparation and sown into soil. After about 2 weeks, the bush bean plants are infested with the greenhouse red spider mite (Tetranychus urticae).

After the desired period of time, the effect in % is determined. 100% means that all of the spider mites have been killed; 0% means that none of the spider mites have been killed.

In this test, the following product showed good systemic action:

TABLE 6
Tetranychus urticae on bush beans

| | | Time at which the | |
|---|---|---|---|
| | | mortality is | |
| | Concentration | determined/days after | |
| Active compound | (mg of ai/plant) | infestation | % Activity |
| (I-4) SC 025 | 1 | 7 | 100 |
| according to the | | | |
| invention | | | |

### Example No. 7

### Liriomyza trifolii Test on Bush Beans; Drench Application

| | |
|---|---|
| Solvent: | 4 parts by weight of acetone |
| Emulsifier: | 1 part by weight of alkylaryl polyglycol ether |

To produce a suitable preparation of active compound, 1 part by weight of active compound is mixed with the stated amounts of solvent and emulsifier, and the concentrate is diluted with water to the desired concentration.

Bush bean plants (Phaseolus vulgaris) are watered with the respective product solution. The stated concentration refers to the amount of active compound per plant. After about 1 week, the treated plants are infested with the leaf-mining fly (Liriomyza trifolii).

After 2 weeks, the effect in % is determined. 100% means that all of the leaf-mining flies have been killed; 0% means that none of the leaf-mining flies have been killed.

In this test, the following product showed good systemic action:

TABLE 7
Liriomyza tr. on bush bean

| | | Time at which the | |
|---|---|---|---|
| | | mortality is | % Activity |
| | Concentration | determined/days after | (according to |
| Active compound | (mg of ai/plant) | infestation | Abbott) |
| (I-4) | 0.5 | 14 | 100 |
| according to the | | | |
| invention | | | |

### Example No. 8

### Tetranychus urticae Test on Bush Beans; Drench Application

| | |
|---|---|
| Solvent: | 4 parts by weight of acetone |
| Emulsifier: | 1 part by weight of alkylaryl polyglycol ether |

To produce a suitable preparation of active compound, 1 part by weight of active compound is mixed with the stated amounts of solvent and emulsifier, and the concentrate is diluted with water to the desired concentration.

Bush bean plants (Phaseolus vulgaris) are watered with the respective product solution. The stated concentration refers to the amount of active compound per plant. After about 1 week, the treated plants are infested with the greenhouse red spider mite (Tetranychus urticae).

After 2 weeks, the effect in % is determined. 100% means that all of the spider mites have been killed; 0% means that none of the spider mites have been killed.

In this test, the following product showed good systemic action:

TABLE 8
Tetranychus u. on bush bean

| | | Time at which the | |
|---|---|---|---|
| | | mortality is | % Activity |
| | Concentration | determined/days after | (according to |
| Active compound | (mg of ai/plant) | infestation | Abbott) |
| (I-4) | 0.25 | 14 | 100 |
| according to the | | | |
| invention | | | |

### Example No. 9

### Liriomyza sativae Test on Aubergines; Drench Application (Japan)

To produce a suitable solution, the formulated product is mixed with water and diluted to the desired concentration.

Aubergine plants (Solanum melongena) at the 8-leaf stage (BBCH 18) infested with a mixed population of leaf-mining flies (Liriomyza sativae) are watered with the respective product solution (volume of water: 30 ml/plant): The stated concentration refers to the amount of active compound per plant.

After the desired period of time, the effect in % is determined. 100% means that all of the leaf-mining flies have been killed; 0% means that none of the leaf-mining flies have been killed.

In this test, the following product showed good systemic action:

TABLE 9
Liriomyza sativae on aubergines

| | | Time at which the | |
|---|---|---|---|
| | | mortality is | % Activity |
| | Concentration | determined/days after | (according to |
| Active compound | (mg of ai/plant) | treatment | Abbott) |
| (I-4) SC 025 | 5 | 7 | 100 |
| according to the | | | |
| invention | | | |

1-9. (canceled)

10. A method of controlling an animal pest of a plant comprising applying a compound of formula (I) 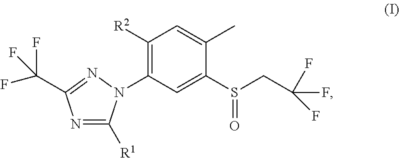
wherein
R¹ represents H or NH₂, and
R² represents CH₃ or F, wherein said compound is applied by watering on the ground, droplet application or dip application of said plant, or by treatment of a seed from which said plant emerges.

11. The method according to claim 10 wherein the animal pest is an insect, spider mite or nematode.

12. The method according to claim 10 wherein the compound of formula (I) is selected from the group consisting of

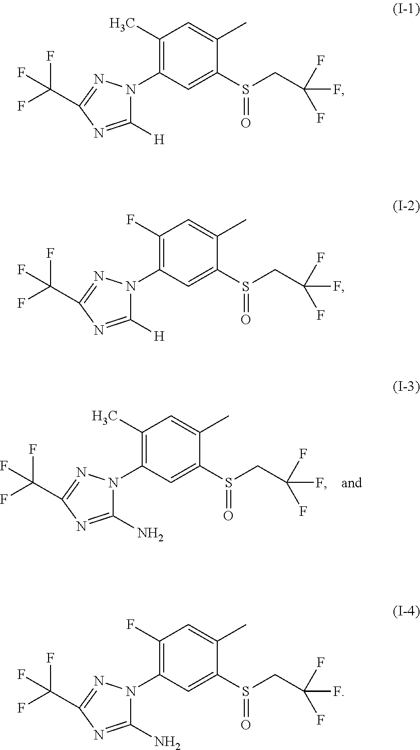

13. The method according to claim 12 wherein the compound of formula (I) is the compound (I-1).

14. The method according to claim 12 wherein the compound of formula (I) is the compound (I-4).

15. The method according to claim 10 wherein the plant is growing in or the seed emerges from an artificial growth substrate.

16. The method according to claim 10 wherein the plant is planted in a closed system.

17. The method according to claim 16 wherein the closed system is a greenhouse.

18. The method according to claim 10 wherein the plant is selected from the group consisting of vegetables, spices, ornamental plants, shrubs, conifers and citrus plants.

19. The method according to claim 10 wherein the compound of formula (I) is applied as a seed treatment.

20. The method according to claim 19 wherein the seed is the seed of a transgenic plant.

21. The method according to claim 10 wherein the compound of formula (I) is the R enantiomer thereof.

22. The method according to claim 10 wherein the compound of formula (I) is the S enantiomer thereof.
